(19) United States
(12) Patent Application Publication
(10) Pub. No.: US 2018/0142131 A1
(43) Pub. Date: May 24, 2018

(54) HIGH VISCOSITY PRIMER

(71) Applicant: OATEY CO., Cleveland, OH (US)

(72) Inventors: Amrit PARHAR, Westlake, OH (US); Willie PEREZ, Hudson, OH (US)

(21) Appl. No.: 15/575,018

(22) PCT Filed: May 27, 2016
(86) PCT No.: PCT/US2016/034673

§ 371 Date: Nov. 17, 2017

Related U.S. Application Data
(60) Provisional application No. 62/167,952, filed on May 29, 2015.

(51) Int. Cl. C09J 101/28; C09J 127/06; C09J 5/02; B05D 3/00

(52) U.S. Cl. CPC C09J 101/28; C09J 127/06; C09J 5/02; B05D 3/002; C09J 2455/003; C09J 2401/003; C09J 2427/003; C09J 2433/003; C09J 2205/306

(57) ABSTRACT

A high viscosity primer and a process for preparing a polymer surface for solvent cement bonding are disclosed. The high viscosity primer has at least one solvent capable of at least partially dissolving or softening the surface and comprising a thickener ethylcellulose, PVC resin, polyvinylpyrrolidone (PVP) resin, acrylic resin, acrylonitrile butadiene styrene (ABS), pentaerythritol ethoxylate, or a combination thereof and present at a concentration in a range of from about 0.5 wt % to about 10 wt %, relative to the total weight of the primer. The high viscosity primer has a viscosity in a range of from about 10 to about 100 centipoise.

### CROSS REFERENCE TO RELATED APPLICATIONS

This application claims priority to U.S. Provisional Application No. 62/167,952, filed May 29, 2015, the entire contents of which are incorporated herein by reference.

### FIELD OF THE INVENTION

This invention relates to primers used in solvent cementing. Particularly, the invention relates to high viscosity primers for use in preparing a surface for solvent cement bonding.

### BACKGROUND OF THE INVENTION

Primers are used in the solvent cement process to help prepare plastic pipes, fittings, surfaces, and other articles or objects for solvent cementing or adhesion by cleaning and softening the object to maximize adhesion once a solvent based adhesive is subsequently applied. The pipes, fittings, or other objects being adhered are typically made from PVC (polyvinyl chloride), CPVC (chlorinated polyvinyl chloride), ABS (acrylonitrile-butadiene-styrene) and other thermoplastics or polymers. Before applying a solvent cement, the surfaces to be joined are normally covered with a primer containing a solvent capable of at least partially dissolving or softening the surface to be bonded. Conventional primers, however, are usually very low viscosity substances, typically having a viscosity below the viscosity of water. Thus, these low viscosity primers are prone to dripping, spilling, and otherwise separating from the surface of the object to be adhered.

Additionally, because many building codes require that plastic piping systems be primed with primers having an intense colorant, conventional primers usually include a purple dye to facilitate visual confirmation of primer application. The combination of the dye with conventional low viscosity primers can lead to unintentional and undesirable staining and discoloration of the surroundings.

### SUMMARY

The present application discloses exemplary embodiments of a high viscosity primer, and packaged products thereof, and methods for preparing a surface for solvent cement bonding. By way of example to illustrate various aspects of the general inventive concepts, several exemplary embodiments of compositions and methods are disclosed herein.

In an exemplary embodiment, the present disclosure is directed to a high viscosity primer for use in preparing a thermoplastic or other polymer-based surface for solvent cement bonding. The high viscosity primer has at least one solvent capable of at least partially dissolving the surface. The primer comprises a dissolved thermoplastic or other polymer thickener in a range of from about 0.5%-10% by weight, relative to the weight of the entire composition. Exemplary embodiments include those in which the concentration of the dissolved thickener is in a range of from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, from about 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. The thermoplastic or other polymer thickener may comprise ethylcellulose, polyvinyl chloride (PVC) resin, polyvinylpyrrolidone (PVP) resin, acrylic resin, acrylonitrile butadiene styrene (ABS), pentaerythritol ethoxylate, and combinations thereof. The high viscosity primer has a viscosity in a range of from about 10 to about 100 centipoise (cP), including without limitation from about 10 to about 90 cP, from about 10 to about 80 cP, from about 10 to about 70 cP, from about 10 to about 60 cP, from about 10 to about 50 cP, from about 20 to about 50 cP, from about 30 to about 40 cP, from about 50 to about 60 cP, from about 60 to about 70 cP, from about 70 to about 80 cP, from about 80 to about 90 cP, from about 90 to about 100 cP, or any combination of these ranges, when measured at 25° C. using ASTM standard test D1084 method B. In some embodiments, the thermoset polymer or thickener is chemically matched with the polymer type of the surface onto which it is intended to be applied.

In certain embodiments, the high viscosity primer consists essentially of the at least one solvent capable of at least partially dissolving the polymer surface and the dissolved thermoplastic or other polymer thickener. Such a high viscosity primary contains no additional components that alter its use as a primer, e.g., before the application of a solvent cement. In yet other embodiments, the high viscosity primer consists of the at least one solvent capable of at least partially dissolving the polymer surface and the dissolved thermoplastic or other polymer thickener, and, optionally, a colorant.

In an exemplary embodiment, the present disclosure is directed to a process for preparing a surface for solvent cement bonding. The process comprises applying a high viscosity primer to the surface and allowing the high viscosity primer to at least partially dissolve the surface. The high viscosity primer includes at least one solvent and a thickener present in a range of from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, from about 0.5 wt % to about 10 wt %. In certain specific embodiments, the thickener is present in a range of from about 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. The thickener is selected from the group consisting of ethylcellulose, PVC resin, PVP resin, acrylic resin, acrylonitrile butadiene styrene (ABS), pentaerythritol ethoxylate, and combinations thereof. The high viscosity primer has a viscosity in a range of from about 10 to about 100 centipoise (cP), including without limitation from about 10 to about 90 cP, from about 10 to about 80 cP, from about 10 to about 70 cP, from about 10 to about 60 cP, from about 10 to about 50 cP, from about 20 to about 50 cP, from about 30 to about 40 cP, from about 50 to about 60 cP, from about 60 to about 70 cP, from about 70 to about 80 cP, from about 80 to about 90 cP, from about 90 to about 100 cP, or any combination of these ranges, when measured at 25° C. using ASTM standard test D1084 method B.

In an exemplary embodiment, the present disclosure is directed to a primer/solvent cement system for use in bonding a plastic object to another object. The primer/solvent cement system comprises a high viscosity primer and a solvent cement. The high viscosity primer contains a first solvent capable of at least partially dissolving the plastic object and further includes a thickener selected from the group consisting of ethylcellulose, PVC resin, PVP resin, acrylic resin, acrylonitrile butadiene styrene (ABS), pentaerythritol ethoxylate, and combinations thereof. The thickener is in a range of from about 0.5 wt % to about 10 wt %. In certain specific embodiments, the thickener is present in a range of from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, from about 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. The high viscosity primer has a viscosity in a range of from about 10 to about 100 centipoise (cP), including without limitation from about 10 to about 90 cP, from about 10 to about 80 cP, from about 10 to about 70 cP, from about 10 to about 60 cP, from about 10 to about 50 cP, from about 20 to about 50 cP, from about 30 to about 40 cP, from about 50 to about 60 cP, from about 60 to about 70 cP, from about 70 to about 80 cP, from about 80 to about 90 cP, from about 90 to about 100 cP, or any combination of these ranges, when measured at 25° C. using ASTM standard test D1084 method B. The solvent cement contains a thermoplastic resin dissolved in a second solvent. In certain embodiments, the solvent cement is separate from the high viscosity primer, e.g., packaged separately, such that the high viscosity primer consists essentially of the at least one solvent capable of at least partially dissolving the polymer surface and the dissolved thermoplastic or other polymer thickener.

Examples of the surfaces that can be primed with the inventive high viscosity primer include without limitation, PVC, chlorinated polyvinyl chloride (CPVC), acrylonitrile butadiene styrene (ABS) and other thermoplastic or plastic pipes, fittings, and other objects and surfaces. The high viscosity primer may be used in combination with solvent cement or plastic adhesives.

### DETAILED DESCRIPTION

The present invention may be understood more readily by reference to the following description taken in connection with the accompanying Figures and Examples, all of which form a part of this disclosure. It is to be understood that this invention is not limited to the specific products, methods, conditions or parameters described or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range.

It is to be appreciated that certain features of the invention which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

The transitional terms “comprising,” “consisting essentially of,” and “consisting” are intended to connote their generally accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents), also provide, as embodiments, those which are independently described in terms of “consisting of” and “consisting essentially” of.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

Throughout this specification, words are to be afforded their normal meaning, as would be understood by those skilled in the relevant art. However, so as to avoid misunderstanding, the meanings of certain terms will be specifically defined or clarified.

Several illustrative embodiments will be described in detail with the understanding that the present disclosure merely exemplifies the general inventive concepts. While embodiments encompassing the general inventive concepts may take various forms, the general inventive concepts are not intended to be limited to the specific embodiments described herein.

In the context of this invention, the adhesively bonded pipes, fittings, articles, objects, or surfaces may comprise PVC (polyvinyl chloride), CPVC (chlorinated polyvinyl chloride), and ABS (acrylonitrile butadiene styrene) plastics. In this context, it will be understood that polymers comprising “PVC,” “CPVC,” “ABS” and similar designations refer to polymers which can include other monomers in addition to the vinyl chloride, acrylonitrile, butadiene and styrene monomers being specifically referred to. Similarly, “polymer” in the context of this disclosure will be understood to include homopolymers, copolymers, terpolymers, etc. In addition to PVC, CPVC and ABS, this invention is applicable to bonding all other types of plastics capable of being adhesively bonded with solvent cements, as well. Examples include HiPS (high impact polystyrene), SAN (styrene acrylonitrile), acrylics and polyamides.

The primers of this invention may comprise conventional primers plus a thickening ingredient added thereto. Although the primers of this invention are most easily made by adding the thickener to a previously-made primer, where the primer is composed of a mixture of solvents, the thickener can be added to one or more of these solvents before the solvents are combined. In accordance with this invention, the thickener may be added to a solvent or solvent mixture to form the high viscosity primer. In certain embodiments, the high viscosity primer consists essentially of the at least one solvent capable of at least partially dissolving the polymer surface and the dissolved thermoplastic or other polymer thickener. In yet other embodiments, the high viscosity primer consists of the at least one solvent capable of at least partially dissolving the polymer surface and the dissolved thermoplastic or other polymer thickener, and, optionally, a colorant.

Essentially any primer that is known for use as a primer for adhesive bonding of surfaces, plastic pipes, fittings, and other articles or objects can be used as the primer base in making the primers of this invention. Generally speaking, these primer bases comprise a solvent or solvent mixture which is capable of softening the surface by at least partially dissolving the surface of a plastic article to which it is applied. Examples include ketones, ethers, esters, amides, carbonates, organic sulfoxides, organic sulfones, organic sulfides, etc. Mixtures of different solvents are common.

Organic solvents which may be of particular interest include acetone (ACE), methyl ethyl ketone (MEK) and other low boiling ketones having boiling points less than 80° C., medium boiling ketones having boiling points of about 80 to 130° C. such as diethyl ketone (DEK), methyl propyl ketone (MPK), methyl iso-propyl ketone (MIPK), methyl iso-butyl ketone (MLBK) and methyl n-butyl ketone (MBK), and high boiling ketones having boiling points greater than 130° C. such as cyclohexanone (CYH), methyl amyl ketone, methyl iso-amyl ketone, di-iso-ketone and ethyl amyl ketone.

In addition to ketones, any of the additional solvents that are typically used in solvent cements may also be used in this invention depending on the particular plastics and co-solvents involved. For example, esters such as methyl acetate, ethyl acetate, ethyl formate, ethyl propionate, and t-butyl acetate can be used as additional solvents, as can halogenated solvents such as methylene chloride, ethylene dichloride, trichloroethylene, dibasic esters, ethers such as methyl Cellosolve and dioxane, and other liquids such dimethylformamide (DMF) and acyclic pentanones, hexanones and heptanones.

THF (tetrahydrofuran), DMSO (dimethyl sulfoxide), NMP (N-methyl pyrrolidone) and GBL (gamma-butyrolactone) can also be used as additional solvents. Similarly, halogenated solvents such as methylene chloride, ethylene dichloride, and trichloroethylene, chlorobenzene, OXSOL 100 (parachlorobenzotrifluoride), and the like, as well as various aromatic compounds such as toluene, xylene, and the like, can also be used as additional solvents.

The present invention comprises a high viscosity primer for use in preparing a surface for solvent cement bonding. The high viscosity primer has at least one solvent capable of at least partially dissolving the surface and also includes a thickener in a range of from about 0.5 wt % to about 10 wt %. In certain specific embodiments, the thickener is present in a range of from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, from about 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. The thickener is selected from the group consisting of ethylcellulose, PVC resin, polyvinylpyrrolidone (PVP) resin, acrylic resin, acrylonitrile butadiene styrene (ABS), pentaerythritol ethoxylate, and combinations thereof. The high viscosity primer has a viscosity in a range of from about 50 to about 100 centipoise (cP), including without limitation from about 10 to about 90 cP, from about 10 to about 80 cP, from about 10 to about 70 cP, from about 10 to about 60 cP, from about 10 to about 50 cP, from about 20 to about 50 cP, from about 30 to about 40 cP, from about 50 to about 60 cP, from about 60 to about 70 cP, from about 70 to about 80 cP, from about 80 to about 90 cP, from about 90 to about 100 cP, or any combination of these ranges, when measured at 25° C. using ASTM standard test D1084 method B.

A preferred ethylcellulose includes an ethylcellulose with an ethoxyl content of 48 to 49.5% and a nominal Ubbelohde viscosity between 270 to 330 centipoise. One example of an ethylcellulose having these properties includes without limitation Ethocel 300. Products identified under the Ethocel trademark are commercially available from Dow Chemical Company.

In accordance with this invention, a thickener is added to a solvent to form a high viscosity primer. In certain embodiments the thickener is ethylcellulose. The ethylcellulose may be in a range of from about 0.5 wt % to about 10 wt %. In certain specific embodiments, the ethylcellulose is present in a range of from about from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. In certain embodiments the ethylcellulose may be about 4% by weight of the entire composition.

In certain embodiments the thickener is PVC resin. Different PVC resins are available, and any grade or type of resin may be used as a thickener in the present primer formulations. The PVC resin may be in a range of from about 0.5 wt % to about 10 wt %. In certain specific embodiments, the PVC resin is present in a range of from about from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. In certain embodiments the PVC resin is about 3% to about 5% by weight of the entire composition. In certain embodiments the PVC resin is about 5% by weight of the entire composition. In certain embodiments the high viscosity primer may comprise about 3% PVC resin and about 2% ethylcellulose.

In certain embodiments the thickener is acrylic resin. The acrylic resin may be in a range of from about 0.5 wt % to about 10 wt %. In certain specific embodiments, the acrylic resin is present in a range of from about from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. In certain embodiments the acrylic resin may be about 1% to about 2% by weight of the entire composition. In certain embodiments the acrylic resin is about 2% by weight of the entire composition. In certain embodiments the high viscosity primer may comprise about 2% acrylic resin and about 3% PVC resin.

In certain embodiments the thickener is PVP resin. The PVP resin may be in a range of from about 0.5 wt % to about 10 wt %. In certain specific embodiments, the PVP resin is present in a range of from about from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. In certain embodiments the PVP resin may be about 1% to about 2% by weight of the entire composition. In certain embodiments the high viscosity primer may comprise about 3% PVC resin and about 2% PVP resin.

In certain embodiments the thickener is ABS resin. The ABS resin may be in a range of from about 0.5 wt % to about 10 wt %. In certain specific embodiments, the ABS resin is present in a range of from about from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. In certain embodiments the ABS resin may be about 1% to about 2% by weight of the entire composition. In certain embodiments the high viscosity primer may comprise about 3% PVC resin and about 2% ABS resin.

In certain embodiments the thickener is pentaerythritol ethoxylate. The pentaerythritol ethoxylate may be in a range of from about 0.5 wt % to about 10 wt %. In certain specific embodiments, the pentaerythritol ethoxylate is present in a range of from about from about 0.5 wt % to about 9 wt %, from about 0.5 wt % to about 8 wt %, from about 0.5 wt % to about 7 wt %, from about 1 wt % to about 6 wt %, from about 1 wt % to about 5 wt %, 0.5 wt % to about 1 wt %, from about 1 wt % to about 2 wt %, from about 2 wt % to about 3 wt %, from about 3 wt % to about 4 wt %, from about 4 wt % to about 5 wt %, from about 5 wt % to about 6 wt %, from about 6 wt % to about 7 wt %, from about 7 wt % to about 8 wt %, from about 8 wt % to about 9 wt %, from about 9 wt % to about 10 wt %, or any combination of these ranges, relative to the weight of the entire composition. In certain embodiments the pentaerythritol ethoxylate may be about 1% to about 2% by weight of the entire composition. In certain embodiments the high viscosity primer may comprise about 3% PVC resin and about 2% pentaerythritol ethoxylate.

In an exemplary embodiment, the high viscosity primer further includes a colorant, which can include without limitation any colorant known to be used or typically found in tinted primers.

In certain embodiments, the high viscosity primer is in a package. Such a package includes, for example, a tube, a canister, or a brush bottle.

The instant primers are not themselves used as solvent cements; they are used to prepare a surface of pipes, fittings, articles, or other objects for bonding as effected by an actual solvent cement composition. For instance, when considered on their own, i.e., when not used in combination with a solvent cement, the presently disclosed primers do not meet the requirements set forth under ASTM D2564 for regular bodied, medium bodied, and heavy bodied cements. More generally, the instant primers, and the methods making use of the primers, do not effect bonding of objects to a useful degree when used in the absence of a solvent cement composition.

In an exemplary embodiment, the present disclosure is directed to a process for preparing a surface for solvent cement bonding. The process comprises applying a high viscosity primer to the surface and allowing the high viscosity primer to at least partially dissolve the surface. The high viscosity primer includes at least one solvent and about 0.5% to about 10% thickener. The process may further include the step of cleaning the surface prior to application of the high viscosity primer. The surface may be made from PVC, CPVC, ABS or combinations thereof. The high viscosity primer may further include a colorant. Additional embodiments include those for applying a solvent bonding cement following this preparation with the primer.

In an exemplary embodiment, the present disclosure is directed to a primer/solvent cement system for use in bonding a plastic object to another object. The primer/solvent cement system comprises a high viscosity primer and a solvent cement. The high viscosity primer contains a first solvent capable of at least partially dissolving the plastic object and one of the aforementioned thickeners or combinations thereof. The solvent cement contains a thermoplastic resin dissolved in a second solvent. In the primer/solvent cement system, the plastic object may comprise PVC, CPVC, ABS or a combination thereof. In some embodiments, the first solvent in the primer/solvent cement system is the same as the second solvent. In other embodiments, the first solvent in the primer/solvent cement system may be different from the second solvent. The high viscosity primer may further include a third solvent. In each case, the solvents may comprise the solvents described above, each for its separate purpose.

### EXAMPLES

The following examples illustrate exemplary embodiments and features of various high viscosity primers encompassed by the general inventive concepts. The examples are given solely for the purpose of illustration and are not to be construed as limiting the present disclosure, as many variations thereof are possible and also encompassed by the general inventive concepts.

In order to more thoroughly describe this invention, the following working examples are provided. In these examples, the high viscosity primers made in accordance with this invention were applied prior to testing an Oatey® PVC Heavy Duty Clear Cement solvent cement (Oatey Co., Cleveland, Ohio) for a two hour lap shear strength and a two hour hydrostatic burst pressure test, both in accordance with ASTM D2564. For the two hour lap shear test, the high viscosity primer was applied to test chips, followed by application of the solvent cement prior to curing of the primer, and bonding of the test chips. The bonded test material was permitted to cure for two hours, and then was tested for lap shear strength. In the two hour hydrostatic burst test, the high viscosity primer was applied to pipes and fittings, followed by application of the solvent cement prior to curing of the primer, and bonding of the test materials. The bonded test material was permitted to cure for two hours, and then was tested for burst strength.

Both experimental and control primers were prepared using Oatey® Purple Primer (Oatey Co., Cleveland, Ohio), which comprises a mixture of THF, CYH, MEK, and acetone. The experimental primers further contained thickener comprising the resin material(s) shown in Table 1 (Examples 1-4). In accordance with the relevant standard, in all experiments, the solvent cement was immediately applied while the test or control primer was still wet following application onto the test materials. Table 1, below, provides the results of the lap shear strength and hydrostatic pressure burst tests.

TABLE 1

| | | | | | | 2 hr |
|---|---|---|---|---|---|---|
| | | | | | | hydrostatic |
| | | | | | 2 hr lap | burst |
| | | | | | shear | pressure |
| | Ethyl | | | | strength | test |
| | Cellulose | PVC | Acrylic | Solvent | (ASTM | (ASTM |
| | (wt %) | (wt %) | (wt %) | (wt %) | D2564) | D2564) |
| Ex. 1 | 4 | — | — | 96 | 312 | 540 |
| Ex. 2 | 2 | 3 | — | 95 | 298 | 620 |
| Ex. 3 | — | 3 | 2 | 95 | 308 | 630 |
| Ex. 4 | — | 5 | — | 95 | 364 | 680 |
| control | — | — | — | 100 | 279 | 640 |

| | | |
|---|---|---|
| ASTM D2564 requirement: | ≥250 | ≥400 |

As illustrated in Table 1, the lap shear strength of the bonded parts was higher when the primer was the inventive high viscosity primer, rather than the conventional primer without thickener. Additionally, the results of the two hour burst test demonstrated that the bonded parts that made use of the inventive high viscosity primers remained above the minimum value required under ASTM D2564.

The foregoing description of the preferred embodiments of the present invention has been presented for purposes of illustration and description. It is not intended to be exhaustive or to limit the invention to the precise form disclosed. Modifications or variations are possible in light of the above teachings. A high viscosity primer in accordance with the present invention may include any combination or sub-combination of the features or concepts disclosed by the present application.

As those skilled in the art will appreciate, numerous modifications and variations of the present invention are possible in light of these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

1. A high viscosity primer suitable for preparing a surface for solvent cement bonding, the primer comprising:
at least one solvent capable of at least partially dissolving or softening a polymer surface; and
about 0.5% to about 10% by weight of a thickener, relative to the weight of the entire primer, comprising ethylcellulose, PVC resin, polyvinylpyrrolidone (PVP) resin, acrylic resin, acrylonitrile butadiene styrene (ABS) resin, pentaerythritol ethoxylate, or a combination thereof;
wherein the high viscosity primer has a viscosity of about 10 to about 100 centipoise at 25° C., when measured according to ASTM D1084 Method B.

2. The high viscosity primer of claim 1, wherein the high viscosity primer comprises ethylcellulose, the ethylcellulose present at a concentration in a range of from about 2 wt % to about 6 wt %, relative to the weight of the entire primer.

3. The high viscosity primer of claim 1, wherein the high viscosity primer comprises a PVC resin, the PVC resin present at a concentration in a range of from about 3 wt % to about 5 wt %, relative to the weight of the entire primer.

4. The high viscosity primer of claim 1, wherein the high viscosity primer comprises a PVC resin, the PVC resin present at a concentration in a range of from about 3 wt % to about 7 wt %, relative to the weight of the entire primer.

5. The high viscosity primer of claim 1, wherein the high viscosity primer is comprises a PVC resin, present at a concentration in a range of about 4 wt % to about 6 wt %, and ethylcellulose, present at a concentration in a range of about 1 wt % to about 3 wt %, in each case relative to the weight of the total primer.

6. The high viscosity primer of claim 1, wherein the high viscosity primer comprises a PVP resin, the PVP resin present at a concentration in a range of from about 1 wt % to about 2 wt %, relative to the weight of the entire primer.

7. The high viscosity primer of claim 1, wherein the high viscosity primer comprises an acrylic resin, the acrylic resin present at a concentration in a range of from about 1 wt % to about 2 wt %, relative to the weight of the entire primer.

8. The high viscosity primer of claim 1, wherein the high viscosity primer comprises an acrylic resin, present at a concentration in a range of from about 1 wt % to about 3 wt %, and a PVC resin, present at a concentration in a range of from about 2 wt % to about 4 wt %, in each case relative to the weight of the entire primer.

9. The high viscosity primer of claim 1, wherein the high viscosity primer comprises a PVC resin, present at a concentration in a range of from about 2 wt % to about 4 wt %, and a PVP resin, present at a concentration in a range of from about 2 wt % to about 4 wt %, in each case relative to the weight of the entire primer.

10. The high viscosity primer of claim 1, wherein the polymer surface comprises PVC, CPVC, ABS or a combination thereof.

11. The high viscosity primer of claim 1, wherein the high viscosity primer further includes a colorant.

12. The high viscosity primer of claim 1, wherein the primer is packaged within a tube, canister, or brush bottle.

13. A process comprising:
(a) pretreating a polymer surface by applying a high viscosity primer to a polymer surface, the high viscosity primer comprising:
at least one solvent capable of at least partially dissolving or softening the polymer surface; and
a first resin comprising ethylcellulose, PVC resin, polyvinylpyrrolidone (PVP) resin, acrylic resin, acrylonitrile butadiene styrene (ABS) resin, pentaerythritol ethoxylate, or a combination—thereof, the first resin present in the primer at a concentration in a range of from about 0.5 wt % to about 10 wt %, relative to the total weight of the primer;
wherein the high viscosity primer has a viscosity of about 10 to about 100 centipoise at 25° C., when measured according to ASTM D1084 Method B; and
(b) allowing the high viscosity primer to at least partially dissolve or soften the surface.

14. The process of claim 13, further comprising cleaning the surface prior to application of the high viscosity primer.

15. The process of claim 13, wherein the surface comprises PVC, CPVC, ABS or a combination thereof.

16. The process of claim 13, wherein the high viscosity primer further comprises a colorant.

17. The process of claim 13, further comprising applying a solvent cement containing a second resin dissolved in a second solvent to the pretreated polymer surface.

18. The process of claim 17, wherein the second resin is a thermoplastic resin.

19. The process of claim 17, wherein the first and second resins are of the same chemistry.

20. A primer/solvent cement system for use in bonding a plastic object to another object comprising:
(a) a high viscosity primer comprising
a first solvent capable of at least partially dissolving a surface of the plastic object and
a thickener comprising ethylcellulose, PVC resin, polyvinylpyrrolidone (PVP) resin, acrylic resin, acrylonitrile butadiene styrene (ABS) resin, pentaerythritol ethoxylate, or a combination thereof,
wherein the thickener is present at a concentration of from about 0.5 wt % to about 10 wt %, relative to the total weight of the high viscosity primer, and wherein the high viscosity primer has a viscosity of in a range of from about 10 to about 100 centipoise at 25° C., when measured according to ASTM Test D1084 Method B; and
(b) a solvent cement containing a thermoplastic resin dissolved in a second solvent.

21. The primer/solvent cement system of claim 20, wherein the plastic object is made from a polymer comprising PVC, CPVC, ABS or a combination thereof.

22. The primer/solvent cement system of claim 20, wherein the first solvent is the same as the second solvent.

23. The primer/solvent cement system of claim 20, wherein the first solvent is different from the second solvent.

24. The primer/solvent cement system of claim 20, wherein the high viscosity primer further includes a third solvent.
